(19) United States
(12) Patent Application Publication
(10) Pub. No.: US 2026/0301266 A1
(43) Pub. Date: Oct. 1, 2026

(54) SYSTEM FOR GENERATING AND DISPLAYING AI-CREATED DIGITAL ART AND METHOD THEREOF

(71) Applicant: IDM Management LLC, Salt Lake City, UT (US)

(72) Inventor: Casey Isom, Salt Lake City, UT (US)

(73) Assignee: IDM Management LLC, Salt Lake City, UT (US)

(21) Appl. No.: 19/573,605

(22) Filed: Mar. 20, 2026

Related U.S. Application Data
(60) Provisional application No. 63/779,039, filed on Mar. 27, 2025.

(51) Int. Cl. G06T 11/60; G06F 3/14; G06F 3/16; G06F 16/215; G06F 16/2457; G06F 40/40; G06T 19/00

(52) U.S. Cl. CPC G06T 11/60; G06F 3/14; G06F 16/215; G06F 16/2457; G06F 40/40; G06T 19/006; G06F 3/167; G06T 2200/24

(57) ABSTRACT

A system, method, and non-transitory computer-readable medium for dynamically generating, deduplicating, and securely displaying context-aware digital artwork. A cloud-based prompt management module receives artwork generation requests and queries a historical database utilizing time-to-live (TTL) constraints to identify and exclude previously utilized text prompts. To prevent generative duplication, a secondary module fetches existing prompts to construct a contextual baseline, injecting it as a negative constraint into a large language model to dynamically generate novel prompts. A selected unique prompt is processed by an image generation model to create a digital image file. An event-driven scheduling module generates a secure, time-limited resource locator for the image file and transmits it via a secure asynchronous data payload. A designated Internet-connected display unit, comprising a secure communication module, extracts the resource locator from the payload, downloads the image file to a local solid-state cache, and renders the unique artwork.

### PRIORITY CLAIM

This application claims the benefit of and priority to U.S. Provisional Patent Application No. 63/779,039, filed Mar. 27, 2025, which is hereby incorporated by reference in its entirety.

### 1. Field of the Invention

Embodiments of the present invention relate to artificial intelligence (AI)-created art and specifically to a system and method for generating and displaying AI-created digital art.

### 2. Relevant Technology

The concept of digital art has evolved significantly over the years, paralleling advancements in computing, artificial intelligence, and display technologies. In the early days of digital art, computer-generated graphics were primarily used for experimental and commercial applications. With the advent of digital painting software and graphic design tools, artists began to embrace digital platforms as a legitimate medium for creative expression. This led to the rise of digital galleries, NFT-based artworks, and interactive installations that could change based on environmental factors or user interactions.

Despite these advancements, the methods of displaying digital art have remained largely static. Most digital art displays today are limited to showcasing fixed image libraries, either curated by users or provided by manufacturers. While some high-end digital frames support cloud-based content streaming, they still require manual intervention for updates and do not provide real-time customization based on user preferences or schedules. This gap highlights the need for a smarter system that integrates artificial intelligence to generate and display unique digital artwork on demand, eliminating the constraints of traditional content curation.

Digital art displays have become a popular medium for showcasing artistic content in homes, offices, galleries, and commercial spaces. These displays serve as a modern alternative to traditional framed artwork, offering the flexibility to change images at will without requiring physical replacements. However, the current state of digital art display systems is largely limited to preloaded or manually updated content. This presents several challenges, particularly in terms of personalization, automation, and real-time updates, which restrict users from having a seamless and dynamic artistic experience.

In traditional digital displays, users often need to upload images manually or rely on cloud-based libraries that contain static selections. While these approaches provide some level of flexibility, they fall short in catering to individual tastes and evolving preferences. Moreover, most digital art frames operate as passive display units, unable to create new content or adapt dynamically to user moods, events, or aesthetic desires. As a result, there is a growing need for an AI-powered system that can generate, schedule, and display digital artwork based on real-time inputs, ensuring a constantly refreshed and unique visual experience.

There are many challenges with current digital art display. Most digital art frames come with a set of preloaded images or offer limited access to online galleries. Users have to manually select images, and the options are often constrained to predefined categories. Currently, there is no integrated mechanism for the automated displaying of dynamically generating unique artwork based on user-defined criteria. The demand for personalized digital art is driven by several factors, including the increasing adoption of smart home technology, the rise of AI-generated creativity, and the desire for more engaging and interactive visual experiences. Today's consumers expect a higher level of customization in their digital environments, whether it be in the form of personalized playlists, tailored content recommendations, or adaptive lighting systems. Similarly, the realm of digital art can greatly benefit from a system that understands user preferences and continuously delivers fresh, relevant content.

Homeowners, for instance, might want their digital displays to reflect their mood, the season, special occasions, or other preferences. A system that generates AI-driven artwork tailored to user inputs—such as preferred styles, color schemes, thematic elements, emotional tones, or contextual factors-would create a more immersive and meaningful experience. Likewise, businesses, commercial spaces, public venues, healthcare facilities, educational institutions, and other organizations can use such a system to maintain a rotating selection of artwork that aligns with their brand identity, corporate culture, therapeutic goals, educational objectives, customer engagement strategies, or other purposes. Hotels, hospitals, office buildings, retail stores, restaurants, galleries, museums, airports, and other venues could implement AI-generated art to enhance ambiance, reduce stress, create visually stimulating environments, promote products or services, or achieve other objectives for guests, patients, employees, customers, visitors, and other individuals.

Additionally, many existing solutions rely on curated art libraries, which may not always align with individual user preferences. While some services offer subscription-based access to new artwork, these selections are still pre-created rather than dynamically generated. Traditional digital frames do not analyze user preferences, moods, or contextual factors to adjust the displayed content. As a result, users are left with a rigid and uninspired viewing experience. Thus, the businesses that want to leverage digital art displays for branding or customer engagement often face the challenge of keeping content fresh and relevant. Manually updating artwork across multiple locations can be resource-intensive and inefficient.

Therefore, the present invention provides a system for generating and displaying AI-created digital art.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope.

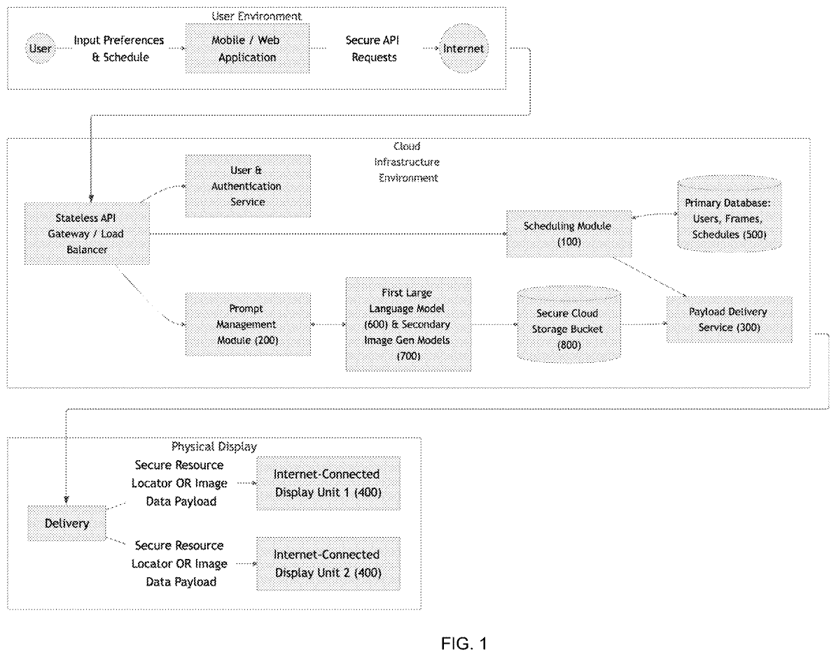

Referring now to FIG. 1, an overarching system environment for generating, scheduling, and delivering dynamically created digital artwork is illustrated. The system architecture utilizes a distributed cloud computing environment to manage generation requests and payload delivery to one or more Internet-connected display units (400). A user interacts with the system via a mobile or web application to input aesthetic preferences, contextual parameters, and scheduling rules. These inputs are transmitted over a network, such as the Internet, via secure API requests to a stateless API Gateway or Load Balancer, which enables horizontal scaling and session-independent request processing.

The cloud infrastructure environment comprises a plurality of orchestrated modules executed by one or more processor units. A scheduling module (100) parses the incoming user parameters and interfaces with a primary database (500) to store and retrieve user profiles, frame registry data, and specific scheduling records. When a time-based or contextual trigger is met, the scheduling module (100) communicates with a prompt management module (200). The prompt management module (200) ensures the generation of unique artwork by tracking previously displayed content and formulating anti-duplication constraints, which are subsequently transmitted to a first Large Language Model (LLM) (600) and a secondary image generation model (700).

Upon generation, the resulting digital image file is optimized, resized, and stored in a secure cloud storage bucket (800). The system then utilizes a payload delivery service (300) to transmit the image data to the designated Internet-connected display unit (400). In various embodiments, this delivery may occur via generating a secure, time-limited resource locator and transmitting said locator through a secure asynchronous data payload to the display unit (400), or via a web service client polling mechanism. In alternative embodiments, the payload delivery service (300) may bypass the resource locator entirely and transmit the digital image file directly to the display unit (400) as an encoded image data payload.

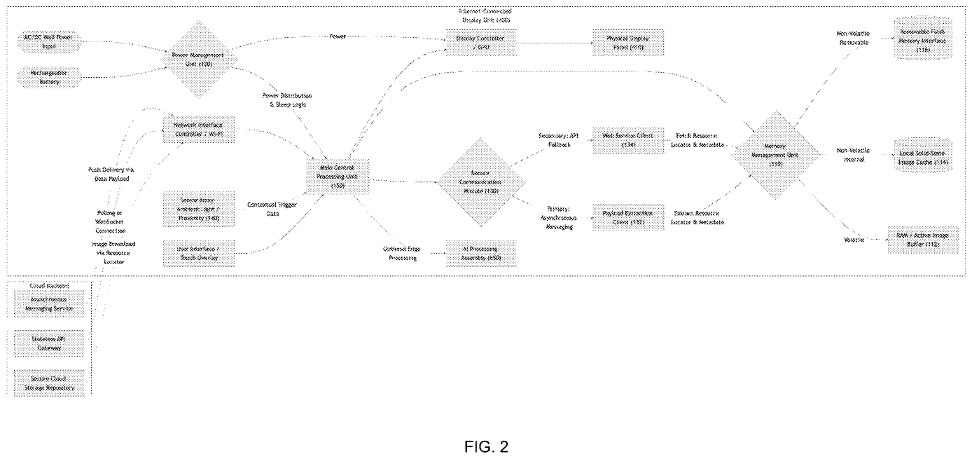

Referring now to FIG. 2, a detailed block diagram of the Internet-connected display unit (400) hardware architecture is shown. To facilitate the seamless display of high-resolution AI-generated art without persistent network reliance, the display unit (400) comprises a main central processing unit (CPU) (150) operably coupled to a specialized memory management unit (110). The memory management unit (110) intelligently routes incoming image payloads between a volatile RAM active image buffer (112) and non-volatile storage. The non-volatile storage may include an internal solid-state high-resolution image cache (114) and a removable flash memory interface (116), allowing for local caching of scheduled art to mitigate network latency or offline states.

The display unit (400) further comprises a power management unit (PMU) (120) configured to distribute power from an AC/DC wall input, a rechargeable battery, or a combination thereof. The PMU (120) dictates power states and sleep logic, which may be dynamically adjusted based on inputs from an onboard sensor array (140). The sensor array (140) may comprise ambient light sensors to adjust display brightness, and proximity or motion sensors to trigger the CPU (150) to transition the physical display panel (410) from a low-power sleep state to an active state when a user enters the viewing vicinity.

To securely receive dynamically generated art payloads, the CPU (150) interfaces with a secure communication module (130). In a preferred embodiment, the secure communication module (130) includes an asynchronous payload extraction client (132) configured to receive secure asynchronous data payloads from the cloud backend, extract a secure, time-limited resource locator and metadata from the payload body, and initiate a secure download of the image file directly to the memory management unit (110). In alternative embodiments, the secure communication module (130) may utilize a web service client (134) to fetch payloads via an API or maintain a persistent WebSocket connection with the cloud backend if the primary extraction client (132) experiences a communication failure. In alternative embodiments, the CPU (150) may be operably coupled to an artificial intelligence-powered processing assembly (650), such as a dedicated Neural Processing Unit (NPU), configured to execute the secondary image generation model locally on the display unit, thereby bypassing the need for cloud-based image generation.”

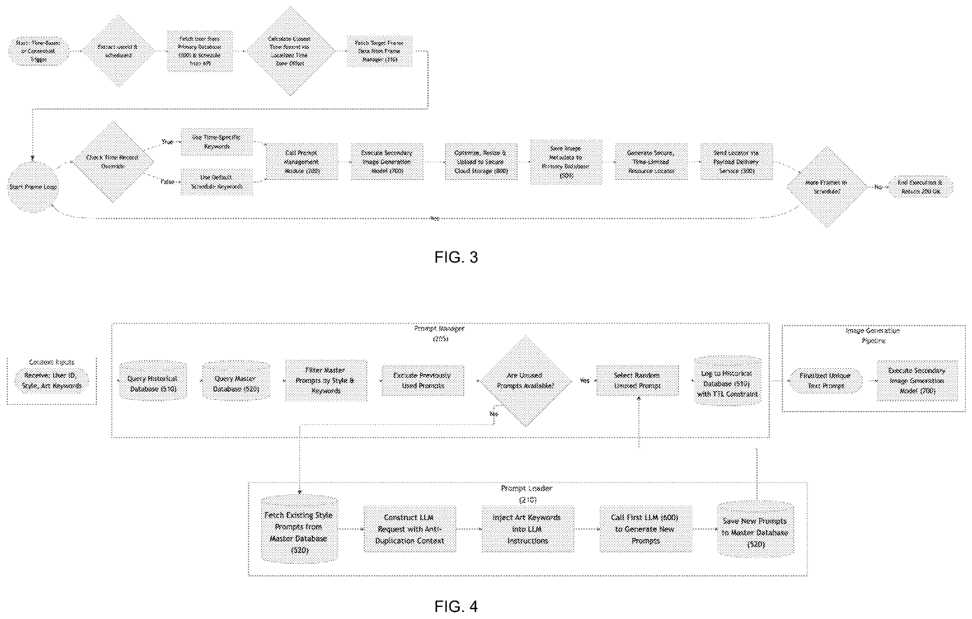

Referring now to FIG. 3, a logic flowchart illustrating the method of the event-driven scheduling module (100) is shown. The process initiates via a time-based or contextual trigger. Upon triggering, the module extracts a user identifier and a schedule identifier to fetch the corresponding user profile and scheduling logic from a primary database (500). To account for global deployment, the system executes a time calculation logic utilizing a localized time zone offset to precisely determine the closest applicable time record for the user's specific timezone.

Once the correct time record is identified, the system fetches target display unit data from a frame management service (310). A loop sequence is initiated for each target display unit (400). Within the loop, the system executes a conditional check to determine if a time-specific keyword override is present. If the condition is met, the system prioritizes the time-specific keywords; otherwise, it defaults to the baseline schedule keywords. The module subsequently formats an API request containing these keywords and the user's selected art style, transmitting the request to the prompt management module (200) (detailed in FIG. 4).

Upon receiving the finalized, unique prompt from the prompt management module (200), the scheduling module (100) calls a secondary image generation model (700) to generate the raw digital artwork. The resulting image file undergoes an optimization and resizing process suitable for the target display unit's (400) physical panel, and is subsequently uploaded to a secure cloud storage bucket (800). The metadata associated with the generation, including a unique prompt identifier, is logged into the primary database (500). Finally, the system generates a secure, time-limited resource locator and triggers the asynchronous delivery module to transmit the locator to the display unit (400), concluding the execution loop.

Referring now to FIG. 4, a data-flow diagram of the distributed prompt management module (200) is illustrated. The prompt management module (200) provides a specific technological solution to the problem of repetitive content generation by enforcing strict anti-duplication constraints. The engine comprises a first module (a prompt manager (205)) and a secondary module (a prompt loader (210)).

Upon receiving the style and keyword parameters from the scheduling module (100), the prompt manager (205) queries a historical database (510) to retrieve a list of previously displayed prompt identifiers associated with the specific user. In a preferred embodiment, these historical records utilize a Time-To-Live (TTL) expiration constraint, ensuring older prompts eventually cycle back into availability. The prompt manager (205) then queries a master database (520) of available prompts, applies a filter based on the requested style and keywords, and algorithmically excludes any prompts matching the active historical records.

If the filtering process yields available unused prompts, a random selection is made, logged into the historical database (510) with a new TTL timestamp, and returned to the scheduling module (100). However, if the filtering process returns a null value (indicating all applicable prompts have been recently used), the prompt manager (205) triggers the prompt loader module (210).

The prompt loader (210) is configured to dynamically expand the master database (520) in real-time. It achieves this by fetching a plurality of existing prompts from the master database (520) to serve as contextual boundaries. It then constructs a highly specific request to a first Large Language Model (LLM) (600), explicitly injecting the fetched existing prompts alongside strict anti-duplication instructions and the user's requested art keywords. The first LLM (600) generates a novel set of prompt strings, which the prompt loader (210) inserts into the master database (520). Control is then returned to the prompt manager (205) to select one of the newly minted, guaranteed-unique prompts to be executed by the secondary image generation model (700).

### SUMMARY OF THE INVENTION

The following summary is provided to facilitate an understanding of some of the innovative features unique to the present disclosure and is not intended to be a full description. A full appreciation of the various aspects of the disclosure can be gained by taking the entire specification, claims, drawings, and abstract as a whole.

The present invention relates generally to a comprehensive system, method, and non-transitory computer-readable medium for dynamically generating, deduplicating, scheduling, and securely displaying context-aware digital artwork. To overcome the limitations of static digital art displays and repetitive artificial intelligence (AI) outputs, the disclosed architecture utilizes a highly specialized, distributed cloud computing backend in secure communication with a purpose-built, Internet-connected physical display unit.

In one embodiment, the system executes a method for prompt deduplication to guarantee the generation of unique digital artwork over time. A cloud-based prompt management module receives an artwork generation request containing a user identifier and stylistic parameters. The module queries a historical database utilizing a Time-To-Live (TTL) expiration constraint to identify previously displayed prompts, and algorithmically excludes them from a filtered master database of available prompts. If the available prompt pool is exhausted, a secondary module dynamically fetches existing prompts and injects them as negative constraints into a Large Language Model (LLM) payload, explicitly instructing the LLM to generate novel, non-duplicative prompt strings to replenish the database. A selected unique prompt is then passed to an image generation model to create the digital artwork.

In another aspect, the system utilizes an event-driven scheduling module configured to calculate localized time zone offsets for globally distributed display units. The module analyzes user-defined schedules to identify time-specific or context-specific keyword overrides, dynamically altering the AI generation parameters. Upon generation of the artwork, the system stores the high-resolution file in a secure cloud repository, generates a secure, time-limited resource locator, and packages the locator into a secure asynchronous data payload for delivery.

To securely receive and display the dynamically generated artwork without reliance on persistent network connectivity, the system comprises a highly specialized Internet-connected display unit. The display unit features a secure communication module equipped with an asynchronous payload extraction client configured to extract the resource locator from the incoming data payload and initiate a secure download. An onboard memory management unit intelligently routes the downloaded image data to a local, non-volatile solid-state image cache or an expandable removable flash memory interface, ensuring uninterrupted display capabilities during network outages.

In further embodiments, the display unit incorporates a power management unit (PMU) configured to distribute power from an AC/DC wall input and an integrated rechargeable battery. The PMU dictates power states based on inputs from an integrated sensor array, transitioning the display from a low-power sleep state to an active state upon detecting user proximity. Additional user interfaces, including capacitive touch overlays, stylus inputs, microphone arrays for voice commands, and spatial gesture-recognition sensors, allow users to instantly override scheduled logic and manually trigger real-time artwork modifications. Furthermore, the system may generate spatially-mapped, three-dimensional representations of the artwork for interaction within a paired Augmented Reality (AR) environment.

### DETAILED DESCRIPTION OF THE PREFERRED EMBODIMENTS

In the following detailed description, numerous specific details are set forth in order to provide a thorough understanding of the embodiment of the invention as illustrative or exemplary embodiments of the invention, specific embodiments in which the invention may be practiced are described in sufficient detail to enable those skilled in the art to practice the disclosed embodiments. However, it will be obvious to a person skilled in the art that the embodiments of the invention may be practiced with or without these specific details. In other instances, well-known methods, procedures and components have not been described in detail so as not to unnecessarily obscure aspects of the embodiments of the invention.

The following detailed description is, therefore, not to be taken in a limiting sense, and the scope of the present invention is defined by the appended claims and equivalents thereof. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. References within the specification to “one embodiment,” “an embodiment,” “embodiments,” or “one or more embodiments” are intended to indicate that a particular feature, structure, or characteristic described in connection with the embodiment is included in at least one embodiment of the present invention.

Although the terms first, second, etc. may be used herein to describe various elements, these elements should not be limited by these terms. These terms are generally only used to distinguish one element from another and do not denote any order, ranking, quantity, or importance, but rather are used to distinguish one element from another. Further, the terms “a” and “an” herein do not denote a limitation of quantity, but rather denote the presence of at least one of the referenced items.

The conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

The following brief definition of terms shall apply throughout the present invention. The terms “determining”, “measuring”, “evaluating”, “assessing,” “assaying,” and “analyzing” can be used interchangeably herein to refer to any form of measurement and include determining if an element is present or not. (e.g., detection). These terms can include both quantitative and/or qualitative determinations. Assessing may be relative or absolute.

A system for generating and displaying digital content using user-defined parameters for scheduling and personalization. The system may comprise a user device for inputting preferences and schedules. The user device may include, but is not limited to, a smartphone, tablet computer, laptop computer, desktop computer, smart speaker, wearable device, or dedicated control interface. The system may also comprise one or more processor units (150), which may be implemented as a single processor, multiple distributed processors, cloud-based processing resources, edge computing devices, or any combination thereof.

The system may also comprise a scheduling module (100) integrated with the processor unit (150). The scheduling module (100) manages timing and requests for content creation and may be implemented as software, firmware, hardware, or a combination thereof. The scheduling module (100) may operate on one or more servers, cloud-based infrastructure, distributed computing systems, or locally on the user device or Internet-connected display unit (400). The scheduling functionality may be centralized, distributed, or hybrid in nature.

The system may also comprise an artificial intelligence-powered processing assembly (650) linked to the processor unit (150). The artificial intelligence-powered processing assembly (650) is configured to generate digital artwork and may utilize various AI technologies including, but not limited to, generative adversarial networks (GANs), diffusion models, neural style transfer, transformer-based models, variational autoencoders, or any other machine learning or deep learning architecture capable of generating visual content. The AI processing may occur locally, remotely via cloud services, or through a hybrid approach combining local and remote processing.

The system may also comprise at least one Internet-connected display unit (400) operationally coupled to the processor unit (150). The Internet-connected display unit (400) is configured to showcase the generated artwork per the defined schedule. The display unit (400) may be implemented using various display technologies including, but not limited to, LCD, LED, OLED, e-ink, projection systems, holographic displays, or any other visual presentation technology. The display unit (400) may be a standalone device, integrated into furniture or architectural elements, or embedded within existing electronic devices. The internet connectivity may be achieved through Wi-Fi, Ethernet, cellular networks, Bluetooth, or other wired or wireless communication protocols.

In an embodiment of the present disclosure, the user device may host a software application, web-based interface, native application, or other interactive interface that allows the users to set preferences such as art style, color palette, display frequency, and other parameters. The preferences may be entered through various input methods including, but not limited to, graphical user interfaces, voice commands, text input, gesture controls, or automated detection of user preferences. The user may schedule artwork changes for specific times of the day such as, calming landscapes in the morning, abstract designs in the evening, or any other time-based or event-based scheduling. In some embodiments, the artwork generated by the artificial intelligence-powered processing assembly (650) can be tailored by the software application, user input, automated preference learning, environmental sensors, or contextual information from connected devices or services.

In an embodiment of the present disclosure, the artificial intelligence-powered processing assembly (650) may generate unique artwork based on the user's input and transmits it to a digital display. In an embodiment of the present disclosure, the Internet-connected display unit (400) may update automatically, providing a seamless and evolving artistic experience without manual intervention. In some embodiments, the Internet-connected display unit (400) may comprise touch-sensitive capabilities allowing users to interact directly with displayed artwork. The display unit (400) may include integrated sensors for detecting voice commands and gesture inputs, enabling hands-free control of artwork generation and display parameters. The voice-activation system may recognize commands such as “show me abstract art,” “change to landscape mode,” or “generate new artwork now.” The gesture-control functionality may allow users to swipe, pinch, or make specific hand movements to navigate between artworks, adjust settings, or trigger new image generation.

In an embodiment of the present disclosure, the scheduling module (100) may manage artwork updates across multiple locations, enabling businesses, hotels, hospitals, office buildings, or users with multiple residences to coordinate artwork display across numerous Internet-connected display units (400) simultaneously or according to location-specific schedules. Each location may have customized preferences while maintaining centralized control and monitoring capabilities. In some embodiments, the Internet-connected display unit (400) may be voice-activated or gesture-controlled, allowing users to request new artwork instantly.

In some embodiments, the Internet-connected display unit (400) may have augmented reality (AR) integration that allows visitors to explore AI-generated art in 3D spaces, where viewers can use AR-enabled devices such as smartphones, tablets, or AR glasses to view additional layers, animations, or interactive elements overlaid on the displayed artwork. The AR features may enable viewers to walk around the display and experience different perspectives or hidden details of the artwork. In some embodiments, the Internet-connected display unit (400) may use a stylus for providing input or use voice commands to modify the AI-generated base image, allowing users to make real-time adjustments to colors, elements, composition, or style directly on the displayed artwork.

In a preferred embodiment, the scheduling module (100) may dynamically trigger AI content generation via the artificial intelligence-powered processing assembly (650) and display updates without manual intervention. The scheduling module (100) may operate on predetermined time-based triggers, automatically initiating artwork generation and display changes at specified times throughout the day, week, or month. For example, the scheduling module (100) may automatically trigger display of calming, nature-themed artwork in the morning hours (6:00 AM-9:00 AM), transition to energizing abstract designs during midday work hours (12:00 PM-5:00 PM), and switch to contemplative or subdued artwork in the evening (7:00 PM-11:00 PM). The scheduling module (100) may manage complex schedules across multiple time zones for users with displays in different geographic locations. The automation system eliminates the need for manual artwork updates by continuously monitoring the schedule, generating new artwork in advance of scheduled display times, and seamlessly transitioning between artworks at the appropriate moments. The scheduling module (100) may also implement rotation schedules that prevent repetitive display of identical artwork, ensuring a constantly refreshed visual experience. In embodiments with multiple Internet-connected display units (400), the scheduling module (100) may coordinate synchronized displays across all devices, location-specific customized schedules for different display units, or independent schedules tailored to each display's environment and audience.

Another embodiment of the present invention relates to a method for generating and displaying digital content using user-defined parameters for scheduling and personalization. The method may comprise entering image preferences and scheduling details by the user through various input mechanisms. The method may also comprise transmitting the collected information to the scheduling module (100) directly or through intermediate processing. The method may also comprise triggering the artificial intelligence-powered processing assembly (650) by the scheduling module (100), user command, automated detection, sensor input, or contextual event for retrieving or generating the image based on the schedule, user preferences, or real-time conditions. The method may also comprise storing the generated image temporarily or permanently in local or remote storage. The method may also comprise transmitting the generated image to the Internet-connected display unit (400) for viewing, where the transmission may occur in real-time, be pre-cached, or occur in batches. The steps of the method may occur in the order described or in alternative sequences, and certain steps may occur concurrently or be omitted in certain embodiments.

In an embodiment of the present disclosure, the input may include information such as, but not limited to, demographics information, location, and age. In an embodiment of the present disclosure, the input may include image preferences such as, but not limited to, art style, color scheme, image keywords, prompt modifiers (creativity, detail, image size, resolution). The art style preferences may include options such as impressionism, abstract, surrealism, photorealistic, minimalist, cubist, or contemporary styles. The color scheme may specify preferred color palettes, dominant colors, complementary colors, warm or cool tones, monochromatic schemes, or seasonal color preferences. The image keywords may include descriptive terms such as “ocean sunset,” “mountain landscape,” “urban cityscape,” “floral patterns,” or any thematic elements desired by the user. The prompt modifiers may adjust the creativity level (ranging from conservative to highly experimental), detail level (from simple to highly detailed), image size (standard display resolution to high-definition), and output resolution settings. The system may also accept contextual inputs including time of day preferences (morning, afternoon, evening, night), seasonal preferences (spring, summer, fall, winter), mood indicators (calming, energizing, contemplative, joyful), and special occasion tags (holidays, birthdays, anniversaries, celebrations). In some embodiments, the system may track and analyze historical preference patterns by monitoring which artworks the user views longest, which artworks the user saves or favorites, which artworks the user shares or displays repeatedly, and which style or theme preferences emerge over time. The system may use machine learning algorithms to identify these patterns and automatically adjust future artwork generation to align with the user's demonstrated preferences, creating an increasingly personalized experience.

The disclosed invention supports tailored user preferences for artwork style, themes, and scheduling. The disclosed invention provides seamless communication between the user device, the scheduling module (100), the artificial intelligence-powered processing assembly (650), and the Internet-connected display unit (400) through secure network connections and data transmission protocols. The software application hosted on the user device may provide an intuitive interface for users to input and modify their preferences, view generated artwork previews, access artwork history, and manage display schedules across one or more display units (400). The system may store generated artwork images in memory or cloud-based storage, maintaining a library of previously generated artworks that can be recalled, redisplayed, or used as reference for future generations. The system may implement data management protocols to optimize storage by archiving older artworks, maintaining high-priority favorites, and automatically managing storage allocation. The disclosed invention is suitable for home decor with personalized rotating artwork. The disclosed invention is suitable for commercial applications, such as art displays in hotels or offices where centralized management of multiple display units provides operational efficiency and brand consistency. The disclosed invention is suitable for integration with art marketplaces for on-demand content. The system may include analytics capabilities that track user engagement, preference trends, and artwork performance metrics to continuously improve the personalization algorithms. The non-transitory computer-readable medium storing the software instructions may be distributed across user devices, server systems, and display units (400), enabling distributed processing and coordinated operations throughout the entire system.

In a case that no conflict occurs, the embodiments in the present disclosure and the features in the embodiments may be mutually combined. The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed is:

1. A method for dynamically generating and deduplicating contextual digital artwork payloads, the method comprising:
receiving, at a prompt management module executed by one or more processor units distributed across various computing resources, an artwork generation request comprising a user identifier and at least one stylistic parameter;
querying a historical database utilizing the user identifier to retrieve a first set of previously utilized prompt records, wherein each record in the first set comprises a time-to-live (TTL) expiration constraint;
filtering a master database comprising a plurality of available text prompts based on the at least one stylistic parameter to generate a filtered prompt set;
algorithmically excluding any prompts from the filtered prompt set that correspond to the first set of previously utilized prompt records to yield an available prompt pool;
upon determining the available prompt pool is null, dynamically generating a new set of unique prompts by:
fetching a contextual baseline of existing prompts from the master database;
transmitting a generation request to a first large language model (LLM), wherein the generation request explicitly injects the contextual baseline alongside a strict anti-duplication instruction;
receiving the new set of unique prompts from the first LLM; and
inserting the new set of unique prompts into the master database to populate the available prompt pool;
selecting a target text prompt from the available prompt pool;
logging the target text prompt into the historical database with a new TTL expiration constraint associated with the user identifier; and
transmitting the target text prompt to a secondary image generation model to execute the generation of a digital image file for delivery to an Internet-connected display unit.

2. The method of claim 1, wherein the time-to-live (TTL) expiration constraint comprises a dynamic timestamp configured to automatically purge records from the historical database upon expiration of a predefined time window, thereby continuously replenishing the available prompt pool without requiring manual database maintenance.

3. The method of claim 1, wherein transmitting the generation request to the first large language model (LLM) further comprises formatting the contextual baseline of existing prompts as a negative constraint string within an API payload to force the first LLM to generate novel textual outputs that do not semantically match the contextual baseline.

4. The method of claim 1, wherein the artwork generation request is initiated by an event-driven scheduling module, the initiation comprising:
calculating a localized time zone offset to determine a localized time record for the designated Internet-connected display unit;
identifying a time-specific keyword override associated with the localized time record; and
appending the time-specific keyword override to the at least one stylistic parameter prior to transmission to the prompt management module.

5. The method of claim 1, further comprising:
saving the generated digital image file to a secure cloud storage bucket;
generating a secure, time-limited resource locator corresponding to the digital image file; and
formatting the time-limited resource locator into a secure asynchronous messaging payload directed to a specific delivery address assigned to the designated Internet-connected display unit.

6. The method of claim 1, wherein the at least one stylistic parameter is dynamically adjusted prior to filtering the master database based on real-time contextual data associated with the user identifier, the contextual data comprising at least one of: user demographic information, geographical location data, historical preference patterns, calculated mood indicators, environmental context, time of day, season, special occasions, or sensor data aggregated from external connected smart devices.

7. A system for securely receiving and displaying dynamically generated digital artwork, the system comprising:
a physical display panel;
a memory management unit operably coupled to a local non-volatile solid-state image cache and a volatile active image buffer;
a secure communication module comprising an asynchronous payload extraction client; and
a main central processing unit (CPU) configured to:
receive, via the asynchronous payload extraction client, a secure asynchronous data payload originating from a cloud scheduling service;
extract a secure, time-limited resource locator from the secure asynchronous data payload;
execute a secure download of a high-resolution digital image file via the time-limited resource locator;
route the downloaded digital image file to the local non-volatile solid-state image cache via the memory management unit to ensure continuous display capability independent of persistent network connectivity; and
render the digital image file onto the physical display panel.

8. The system of claim 7, further comprising a power management unit (PMU) configured to dynamically distribute power to the main CPU and the physical display panel from
at least one of an AC/DC wall input and a rechargeable battery.

9. The system of claim 8, further comprising an integrated sensor array comprising at least one ambient light sensor and at least one proximity sensor, wherein the PMU is configured to transition the physical display panel from a low-power sleep state to an active display state upon receiving a user proximity trigger from the sensor array.

10. The system of claim 7, wherein the memory management unit is further operably coupled to a removable flash memory interface configured as an expandable secondary non-volatile storage repository for scheduled digital image files.

11. The system of claim 7, wherein the secure communication module further comprises a web service client, and wherein the main CPU is configured to utilize the web service client to fetch the secure, time-limited resource locator if the primary asynchronous payload extraction client experiences a communication failure.

12. The system of claim 7, further comprising a touch-sensitive overlay positioned on the physical display panel, wherein the main CPU is configured to receive localized input data from a stylus or capacitive touch and apply real-time graphical modifications to the rendered digital image file.

13. The system of claim 7, further comprising an integrated microphone and a spatial gesture-recognition sensor, wherein the main CPU is configured to parse user voice commands and physical user gestures to instantly override active scheduling logic and trigger an immediate artwork generation request via the secure communication module.

14. The system of claim 7, wherein the main CPU is further configured to generate and transmit a spatially-mapped, three-dimensional representation of the rendered digital image file to a paired augmented reality (AR) device, enabling user interaction with the generated digital artwork within an extended reality environment.

15. A non-transitory computer-readable medium storing instructions that, when executed by one or more processor units distributed across various computing resources, cause the processor units to perform operations comprising:
receiving, at a prompt management module, an artwork generation request comprising a user identifier and at least one stylistic parameter;
querying a historical database utilizing the user identifier to retrieve a first set of previously utilized prompt records, wherein each record in the first set comprises a time-to-live (TTL) expiration constraint;
filtering a master database comprising a plurality of available text prompts based on the at least one stylistic parameter to generate a filtered prompt set;
algorithmically excluding any prompts from the filtered prompt set that correspond to the first set of previously utilized prompt records to yield an available prompt pool;
upon determining the available prompt pool is null, dynamically generating a new set of unique prompts by:
fetching a contextual baseline of existing prompts from the master database;
transmitting a generation request to a first large language model (LLM), wherein the generation request explicitly injects the contextual baseline alongside a strict anti-duplication instruction;
receiving the new set of unique prompts from the first LLM; and
inserting the new set of unique prompts into the master database to populate the available prompt pool;
selecting a target text prompt from the available prompt pool;
logging the target text prompt into the historical database with a new TTL expiration constraint associated with the user identifier; and
transmitting the target text prompt to a secondary image generation model to execute the generation of a digital image file for delivery to a designated Internet-connected display unit;

16. The non-transitory computer-readable medium of claim 15, wherein the time-to-live (TTL) expiration constraint comprises a dynamic timestamp configured to automatically purge records from the historical database upon expiration of a predefined time window, thereby continuously replenishing the available prompt pool without requiring manual database maintenance.

17. The non-transitory computer-readable medium of claim 15, wherein transmitting the generation request to the first large language model (LLM) further comprises formatting the contextual baseline of existing prompts as a negative constraint string within an API payload to force the first LLM to generate novel textual outputs that do not semantically match the contextual baseline.

18. The non-transitory computer-readable medium of claim 15, wherein the artwork generation request is initiated by an event-driven scheduling module, the initiation comprising:
calculating a localized time zone offset to determine a localized time record for the designated Internet-connected display unit;
identifying a time-specific keyword override associated with the localized time record; and
appending the time-specific keyword override to the at least one stylistic parameter prior to transmission to the prompt management module.

19. The non-transitory computer-readable medium of claim 15, wherein the operations further comprise:
saving the generated digital image file to a secure cloud storage bucket;
generating a secure, time-limited resource locator corresponding to the digital image file; and
formatting the secure, time-limited resource locator into a secure asynchronous messaging payload directed to a specific delivery address assigned to the designated Internet-connected display unit.

20. The non-transitory computer-readable medium of claim 15, wherein the at least one stylistic parameter is dynamically adjusted prior to filtering the master database based on real-time contextual data associated with the user identifier, the contextual data comprising at least one of: user demographic information, geographical location data, historical preference patterns, calculated mood indicators, environmental context, time of day, season, special occasions, or sensor data aggregated from external connected smart devices.
